(19) United States
(12) Patent Application Publication
(10) Pub. No.: US 2014/0190920 A1
(43) Pub. Date: Jul. 10, 2014

(54) Arrangement for Ocean Freight Transportation

(71) Applicants: Raimo Nordström, Espoo (FI); Hannu Nurminen, Mynamaki (FI)

(72) Inventors: Raimo Nordström, Espoo (FI); Hannu Nurminen, Mynamaki (FI)

(21) Appl. No.: 14/209,488

(22) Filed: Mar. 13, 2014

Related U.S. Application Data
(63) Continuation of application No. 13/354,525, filed on Jan. 20, 2012.

(30) Foreign Application Priority Data
Jan. 24, 2011 (FI) 20115061

(51) Int. Cl. B63B 25/00; B65D 19/38; B66C 23/52; B65D 19/00

(52) U.S. Cl. CPC B63B 25/00; B65D 19/0002; B65D 19/38; B66C 23/52
USPC 212/307; 294/68.1

(57) ABSTRACT

An ocean freight arrangement handles goods in a number of transport modes, such as containers, with the same transport in a cargo hold of an ocean vessel with cranes. The transport has a platform with a width corresponding to two regular containers to be loaded and unloaded by two parallel cranes enabling transportation of heavy and over wide units.

### REFERENCE TO RELATED APPLICATION

This application is a continuation of U.S. patent application Ser. No. 13/354,525, filed Jan. 20, 2012 and entitled “Method and Arrangement for Ocean Freight Transportation,” the subject matter of which is hereby incorporated by reference in entirety.

### FIELD OF THE INVENTION

The subject of the invention is a method and arrangement for ocean freight transportation.

### BACKGROUND OF THE INVENTION

U.S. Pat. No. 4,043,285, U.S. Pat. No. 4,294,185, and U.S. Pat. No. 5,183,305 describe cargo vessels suitable for sea transport functions, which vessels have upper level cargo handling equipment and support structures for the loading and unloading of cargo containers. Such vessels, known as “Twinstar”, maximize the load transport capacity, minimize idle time in ports and provide an extremely cost-effective system for the loading and unloading of cargo. The integrated container cranes on the vessels make it possible to achieve optimal efficiency in ports. By effecting saving manpower and time, they specifically decrease or even obviate the need for manual labor for loading and unloading vessels. In addition, a large amount of the transported cargo can be stored in a safe way with a minimum of time spent and with as little labor as possible. Also, loading and unloading operations can be safely carried out even in bad and windy weather conditions.

Furthermore, U.S. Pat. No. 6,230,640 describes a refrigeration arrangement suitable for the purposes mentioned above, which, first of all, includes heat insulation in the surrounding structures of a cargo vessel's hold, and, second, refrigeration units placed in the refrigeration areas that connect to the cargo holds. Thus, it is possible to stack a large volume of containerized cargo in the holds, while keeping it apart from the refrigeration units. The cargo containers supporting the cargo are equipped with numerous ventilation openings in order to direct the refrigeration air both around the cargo and through the containers' internal and external surfaces, and then back again to the refrigeration units.

Although cargo ships of the type described above are extremely efficient in handling regular containers, it has been found that they can also be further used more extensively than before for the transportation of heavy and/or over-width cargo, i.e., for units wider than regular containers. Specially designed heavy-cargo vessels have traditionally been used, where such ships are typically loaded using cranes on the dock, which then load the cargo from the side or from the stern by floating it.

Thus, the traditional heavy-cargo vessels have been designed specifically for transporting heavy units, which means that the areas in the cargo holds are built accordingly. For this reason, the transportation of regular containers on those vessel types is not possible without special arrangements. Therefore, container transportation is usually handled using regular container vessels, which use, for the loading and unloading of cargo, container guides in the holds specially designed for that purpose.

### SUMMARY OF THE INVENTION

The purpose of the transportation method and arrangement in this invention is to effect a significant solution to the above-mentioned problems, and thus, significantly improve the prior art in this area.

The most important benefits that should be mentioned about this transportation method and arrangement, as described in this invention, are the simplicity and efficiency of the associated constructions, and the loading and sea transportation functions, especially due to the fact that the same ocean-going vessels can be utilized both simultaneously and separately, for the transportation of regular containers and of heavy and/or over-wide units.

A favorable application of the transportation method based on the invention encompasses a transportation platform having a bottom part with lifting posts that correspond to the lifting points on regular containers. The posts are designed for the connection of container crane lifting wires, chains or similar items. Thus, the invention allows for the handling of both heavy and/or over-wide units, as well as regular containers, using the standard container cranes on Twinstar-type vessels. Furthermore, the transportation platform, according to the invention, can be placed in the hold area of a cargo vessel, in the same manner as a regular container, and even into the same compartments with regular containers using the container guides in the hold.

Other objects, advantages and salient features of the present invention will become apparent from the following detailed description, which, taken in conjunction with the annexed drawings, discloses a preferred embodiment of the present invention.

### BRIEF DESCRIPTION OF THE DRAWINGS

Referring to the drawings which form a part of this disclosure:

FIGS. 1a-1c are trop, side and rear views of a transportation platform according to an exemplary embodiment of the invention; and

FIG. 2 is a partial end view in section of a cargo hold on an ocean freight vessel according to an exemplary embodiment of the invention.

### DETAILED DESCRIPTION OF THE INVENTION

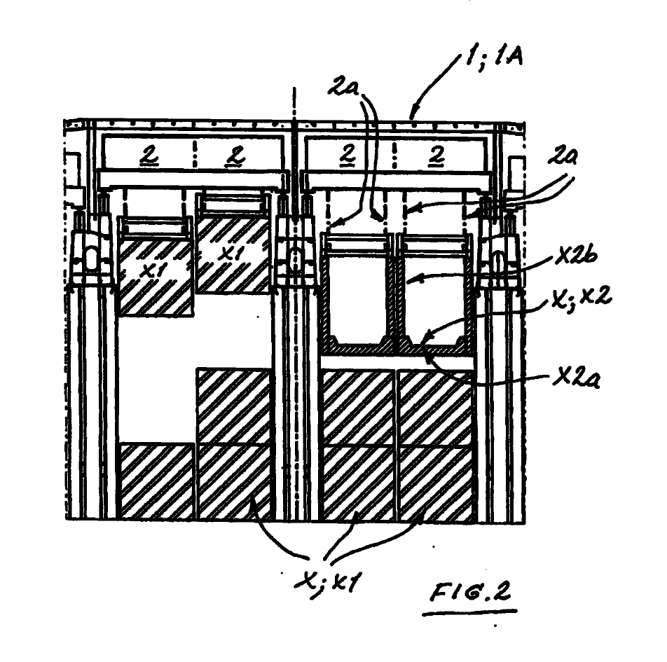

The invention encompasses a method for ocean freight purposes. The transportation arrangement for handling the goods to be transported encompasses a number of means of transport X, such as containers X1 or similar, in order to transport goods with the same means of transport in a cargo hold of an ocean-going freight vessel 1, such as a cargo vessel, a barge or similar. The vessel is specially designed for container transportation and equipped with integrated container cranes 2. With reference to working principles illustrated in the example in FIG. 2, the means of transport is a transportation platform X2. The width L of platform X2 corresponds to two adjacent regular (e.g., 20 foot/40 foot long) transportation containers X1.

This transportation platform is used when the ocean freight vessel 1 is loaded/unloaded with two parallel container cranes 2, in order to enable the transportation of heavy units R and/or over-wide units in the ocean-going vessel's 1 container transportation area 1A.

The invention also encompasses a transportation arrangement for ocean freight purposes, where the transportation arrangement intended for handling the goods to be transported, encompasses a number of means of transport X, such as containers X1 or similar, in order to transport goods with the same means of transport in a cargo hold of an ocean freight vessel 1, such as a cargo vessel, a barge or similar. The vessel is specially designed for container transportation and equipped with integrated container cranes 2. The means of transport used in the transportation arrangement is a transportation platform X2. The width L of platform X2 corresponds to two adjacent regular (e.g., 20 foot/40 foot long) transportation containers X1. This transportation platform is used when the ocean-going freight vessel 1 is loaded/unloaded with two parallel container cranes 2, in order to enable the transportation of heavy units R and/or over-wide units in the ocean-going vessel's 1 container transportation area 1A.

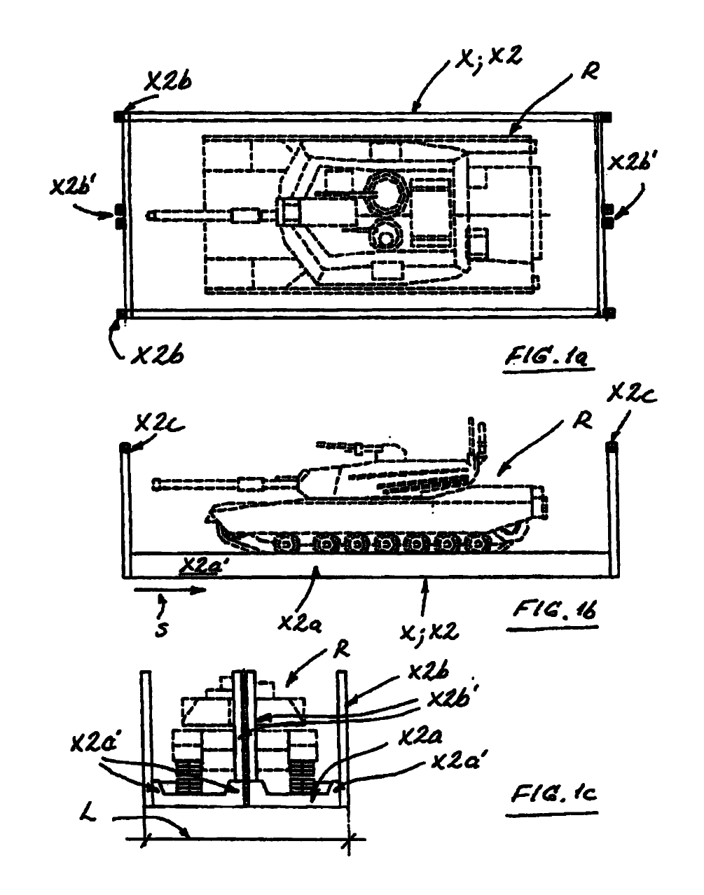

With special reference to the favorable application as illustrated in FIG. 1, the transportation platform X2 encompasses a bottom X2a and lifting posts X2b, arranged on bottom X2a in the locations for regular (20 foot/40 foot) containers' X1 lifting points, for the purpose of connecting the container cranes' 2 lifting wires, chains 2a or similar items.

Furthermore, a favorable application encompasses a stiffening structure installed along the longitudinal s direction are along the transportation platform's X2 bottom X2a, in order to prevent bending. Thus, especially as illustrated in the view from the rear in FIG. 1c, longitudinal elevated structures X2a′ or similar structures are arranged on the bottom's X2a outside edges and in the middle of it.

The transportation platform X2, which is specifically illustrated in FIGS. 1a and 1b encompasses a bottom X2a. The width of bottom X2a corresponds to two regular (40 foot) containers' X1 bottom area, when they are adjacent and parallel to each other. Into the bottom area's corners are connected through arrangements X2c, for example, lifting posts X2b equipped with lifting holes. Thus, a favorable application is further arranged in the midsection of the transportation platform's X2 front and rear edges, at the corresponding lifting points for regular parallel containers, two adjacent connection arrangements X2c, for example, lifting posts X2b′ equipped with lifting holes.

Furthermore, as a favorable practical arrangement, the lifting posts X2b′ installed in the transportation platform's X2 front and/or rear edges have been arranged so that they can be removed/laid down in order to enable the transfer/driving of heavy R and/or over-wide units onto the transportation platform X2.

It is clear that the invention is not limited to the applications presented or explained above, but it can, within the framework of the basic concept of the invention, be modified in many ways, first of all, by equipping the above-described transportation equipment unit types, for example, with deck parts or side plates that can be opened/removed and equipped with quick locking systems, etc., which allows for, for example, protecting the equipment being transported from weather conditions, for example, or for hiding it. In addition, in order to facilitate the storage of transportation equipment, it is possible to arrange all associated lifting posts so that they can be removed or laid down. The parts or subassemblies of the invention's transportation arrangement may consist of diverse materials manufactured using various techniques, in which connection parts of the structures can be of light metal, reinforced plastic, fiberglass, carbon fiber, composite construction, etc.

While one embodiment has been chosen to illustrate the invention, it will be understood by those skilled in the art that various changes and modifications can be made therein without departing from the scope of the invention as defined in the appended claims.

What is claimed is:

1. An arrangement for transporting freight in an ocean vessel, comprising:
freight recurring first platforms having a standard first width, a standard first length and a support surface;
pairs of freight receiving second platforms, the two second platforms of each said pair being arranged and joined parallel to one another and side-by-side to have substantially coplanar support surfaces, to have a second width approximately twice said first width and to have a standard second length substantially equal to said first length; and
loading crane attachments located at corners of each of said first and second platforms, said crane attachments including lifting posts extending substantially perpendicular to said support surfaces of said first and second platforms, said lifting posts adjacent a joint between said second platforms of each said pair and adjacent at least one longitudinal end of each pair being movable to a non-perpendicular position relative to said support surfaces to facilitate loading of freight thereon.

2. An arrangement according to claim 1 wherein
said first and second platforms are stored in a cargo hold of an ocean vessel.

3. An arrangement according to claim 1 wherein
said ocean vessel comprises two adjacent on parallel cranes attachable to said loading crane attachments of said second platforms.

4. An arrangement according to claim 2 wherein
said first platforms are arranged vertically and horizontally relative to said second platforms.

5. An arrangement according to claim 1 wherein
said second platforms have bottoms coupled to said loading crane attachments, said loading crane attachments being coupled to lifting wires or chains of lifting cranes.

6. An arrangement according to claim 5 wherein
stiffeners extend longitudinally along said bottoms resisting bending thereof.

7. An arrangement according to claim 6 wherein
said stiffeners are elevated on said bottoms and extend along longitudinal outside side edges and middles thereof.

8. An arrangement according to claim 1 wherein
said first standard width is about 16 feet; and said standard lengths are about 40 feet.

9. An arrangement according to claim 4 wherein
said lifting posts comprise lifting holes therein.

10. An arrangement according to claim 2 wherein
said first platforms are arranged vertically relative to said second platforms.

11. An arrangement according to claim 2 wherein
said first platforms are arranged horizontally relative to said second platforms.

12. An arrangement wherein for transporting freight in an ocean vessel, comprising:
freight recurring first platforms having a standard first width, a standard first length and a support surface;
pairs of freight receiving second platforms, the two second platforms of each said pair being arranged and joined parallel to one another and side-by-side to have substantially coplanar support surfaces, to have a second width approximately twice said first width and to have a standard second length substantially equal to said first length, said first and second platforms being stored in a cargo hold of an ocean vessel, said first platforms being arranged vertically and horizontally relative to said second platforms; and
loading crane attachments located at corners of each of said first and second platforms.
